(19) United States
(12) Patent Application Publication
(10) Pub. No.: US 2026/0280752 A1
(43) Pub. Date: Sep. 17, 2026

(54) METHOD AND CODEC FOR ENCODING DATA SYMBOL CHAIN AND DECODING ENCODED SYMBOL CHAIN

(71) Applicant: Open Cybernetics LLC, Cheyenne, WY (US)

(72) Inventors: Lum Ramabaja, Cheyenne, WY (US); Dian Fishekqi, Cheyenne, WY (US)

(21) Appl. No.: 19/082,122

(22) Filed: Mar. 17, 2025

(51) Int. Cl. H04L 1/00

(52) U.S. Cl. CPC H04L 1/0041

(57) ABSTRACT

Disclosed is a method and a codec for encoding a data symbol chain and decoding an encoded symbol chain. The method and codec leverage unique mappings between data symbols and encoded symbols, combined with redundant symbols, to ensure reliable decoding. Each data symbol in the data symbol chain maps uniquely to an encoded symbol using identity or negation functions, thereby eliminating random branching during decoding. Each encoded symbol is generated based on a value of a data symbol. The chain header is updated at each instance of generation of an encoded symbol. There is no branching during the decoding because there is no uncertainty regarding a particular source symbol that was used for the generating the encoded symbol. The method prevents collisions by ensuring that no two data symbols map to the same encoded symbol, even in the presence of erasures.

### TECHNICAL FIELD

The present disclosure relates to encoding and decoding of data streams. The present disclosure also relates to a method and a codec for encoding a data symbol chain and decoding an encoded symbol chain.

### BACKGROUND

In data communication and storage systems, ensuring data integrity and reliability is paramount. Traditional coding methods, such as replication and erasure coding, have been widely used to address issues like data loss and corruption during transmission. The erasure coding techniques may be critical in applications such as cloud storage, video streaming, satellite communications, distributed computing, and so on, where data loss and/or corruption can lead to significant performance degradation or service interruptions. However, the coding methods often are affected by inefficiencies in terms of storage overhead, computational complexity, and scalability. Erasure coding, for instance, divides data into fragments and encodes them with redundant fragments to allow recovery of encoded symbols in case of data loss. While effective, conventional erasure coding techniques are likely to be computationally intensive and lack adaptability to dynamic network conditions. Similarly, forward error correction (FEC) codes, which add redundancy to transmitted data, face challenges in balancing redundancy with bandwidth efficiency.

To overcome some of these challenges, information chaining has been proposed. Traditional information chaining methods, which are used for encoding and decoding data symbols, rely on mapping data symbols to encoded symbols. The mapping facilitates recovery from erasures during decoding of encoded symbols. The mapping is such that it allows pruning of incorrect paths during decoding. However, the information chaining methods, such as probabilistic chaining may introduce a risk of collisions, where multiple source symbols map to the same encoded symbol. The collisions may lead to decoding ambiguities, which, in turn, may result in incorrect data reconstruction. The existing information chaining methods may rely on additional redundancy for ensuring reliability, which leads to increases storage and computational overhead.

Handling erasures (missing encoded symbols in encoded symbol chains) in a scalable and efficient manner is a significant challenge, particularly in high-latency or lossy networks. In distributed systems, such as peer-to-peer networks or blockchain systems, where data is transmitted and stored across multiple nodes, efficient scaling remains elusive. Traditional erasure coding methods may require significant computational resources, making them unsuitable for usage in resource-constrained environments.

Therefore, considering the foregoing discussion, there exists a need to overcome the aforementioned drawbacks.

### SUMMARY

The aim of the present disclosure is to provide a method and a codec for encoding a data symbol chain and decoding an encoded symbol chain. Both the method and codec (which includes an encoder and a decoder) implement collision-free information chaining by use of functions such as identity and complement for ensuring that unique mapping between data symbols (in the data symbol chain) and encoded symbols (in the data symbol chain) are obtained. This provides a deterministic approach to both encoding and decoding, thereby eliminating risks of occurrences of random collisions. The method and the codec incorporate mechanisms to effectively handle erasures and errors. By eliminating collisions, accurate data reconstruction is ensured, even in the presence of erasures. The aim of the present disclosure is achieved by the provided method and codec for encoding the data symbol chain and decoding the encoded symbol chain as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers, or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates steps of a method for encoding a data symbol chain for generating an encoded symbol chain, in accordance with an embodiment of the present disclosure;

FIG. 2 illustrates steps of a method for decoding an encoded symbol chain for reconstructing an original data symbol chain, in accordance with an embodiment of the present disclosure; and

FIG. 3 illustrates a block diagram of a codec that is operable to encode a data symbol chain or decode an encoded symbol chain, according to an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In a first aspect, the present disclosure provides a method for encoding a data symbol chain, the method comprising:
initializing a nonce and an overhead factor, wherein the nonce is an initial chain header, and wherein the overhead factor is indicative of an interval between redundant encoded symbols in an encoded symbol chain; and
generating the encoded symbol chain comprising encoded symbols corresponding to data symbols in the data symbol chain and redundant data symbols, wherein the generation includes a set of steps comprising:
   generating an encoded symbol for each data symbol, wherein the encoded symbol is one of: identical to the corresponding data symbol or a complement of the corresponding data symbol,
   updating a chain header based on application of a state change function on the corresponding data symbol and a previous chain header, wherein the previous chain header is the nonce if the corresponding data symbol is a first data symbol in the data symbol chain, and wherein a final chain header is obtained based on the update if the corresponding data symbol is a last data symbol in the data symbol chain, and
   generating a redundant encoded symbol after each instance of generation of a predefined number of encoded symbols that is equal to the overhead factor, and wherein the generation is based on the updated chain header.

In a second aspect, the present disclosure provides a codec for encoding a data symbol chain, wherein an encoder of the codec is operable to:
initialize a nonce and an overhead factor, wherein the nonce is an initial chain header, and wherein the overhead factor is indicative of an interval between redundant encoded symbols in an encoded symbol chain; and
generate the encoded symbol chain comprising encoded symbols corresponding to data symbols in the data symbol chain and redundant data symbols, wherein the generation includes a set of steps comprising:
   generation of an encoded symbol for each data symbol, wherein the encoded symbol is one of: identical to the corresponding data symbol or a complement of the corresponding data symbol,
   updating of a chain header based on application of a state change function on the corresponding data symbol and a previous chain header, wherein the previous chain header is the nonce if the corresponding data symbol is a first data symbol in the data symbol chain, and wherein a final chain header is obtained based on the update if the corresponding data symbol is a last data symbol in the data symbol chain, and
   generation of a redundant encoded symbol after each instance of generation of a predefined number of encoded symbols that is equal to the overhead factor, and wherein the generation is based on the updated chain header.

In a third aspect, the present disclosure provides a method for decoding an encoded symbol chain for reconstructing a data symbol chain, the method comprising:
receiving the encoded symbol chain, a nonce, an overhead factor, and a final chain header, wherein the encoded symbol chain includes encoded symbols and redundant encoded symbols;
initializing a potential path representing a tuple, wherein the tuple includes a decoded symbol chain and a first decoding chain header, and wherein at initialization the decoded symbol chain is empty, and the first decoding chain header is the nonce;
initializing a counter for tracking a number of encoded symbols that have been decoded since encountering a redundant encoded symbol in the encoded symbol chain;
determining that a value of a first encoded symbol in the encoded symbol chain is invalid or missing, and a value of the counter is not equal to the overhead factor;
initializing, based on the determination, a set of candidate tuples, wherein each candidate tuple of the set of candidate tuples includes a candidate decoding path and a candidate second decoding chain header,
   wherein each candidate decoding path includes a candidate value of a first data symbol in the data symbol chain, and
   wherein each candidate second decoding chain header in each candidate tuple is obtained based on application of a state change function on the first decoding chain header and a candidate value of the first data symbol included in the candidate decoding path of the corresponding candidate tuple;
executing a first sequence of steps on determining that a value of a second encoded symbol in the encoded symbol chain is valid, and a value of the counter is not equal to the overhead factor, the first sequence of steps comprising:
   generating a second decoded symbol based the value of the second encoded symbol,
   updating each candidate decoding path in each candidate tuple by including the second decoded symbol in each candidate decoding path such that each candidate decoding path includes a candidate value of the first data symbol and the second decoded symbol, and
   updating each candidate second decoding chain header in each candidate tuple to obtain a candidate third decoding chain header, wherein the update involves an application of the state change function on each candidate second decoding chain header in each candidate tuple and the second decoded symbol;
executing a second sequence of steps on determining that a redundant encoded symbol is encountered in the encoded symbol chain if a value of the counter is equal to the overhead factor, the second sequence of steps comprising:
   generating an expected redundant encoded symbol for each candidate tuple based on the candidate third decoding chain header in each candidate tuple, and
   selecting a candidate tuple from amongst the set of candidate tuples on determining that the expected redundant encoded symbol generated for the candidate tuple is identical to the redundant encoded symbol; and
determining the candidate value of the first data symbol and the second decoded symbol included in the candidate decoding path in the selected candidate tuple as reconstructed versions of the first data symbol and a second data symbol in the data symbol chain, respectively.

In a fourth aspect, the present disclosure provides a codec for decoding an encoded symbol chain for reconstruction of a data symbol chain, wherein a decoder of the codec is operable to:
receive the encoded symbol chain, a nonce, an overhead factor, and a final chain header, wherein the encoded symbol chain includes encoded symbols and redundant encoded symbols;
initialize a potential path representing a tuple, wherein the tuple includes a decoded symbol chain and a first decoding chain header, and wherein at initialization the decoded symbol chain is empty, and the first decoding chain header is the nonce;
initialize a counter for tracking a number of encoded symbols that have been decoded since encountering a redundant encoded symbol in the encoded symbol chain;
determine that a value of a first encoded symbol in the encoded symbol chain is invalid or missing, and a value of the counter is not equal to the overhead factor;
initialize, based on the determination, a set of candidate tuples, wherein each candidate tuple of the set of candidate tuples includes a candidate decoding path and a candidate second decoding chain header,
   wherein each candidate decoding path includes a candidate value of a first data symbol in the data symbol chain, and
   wherein each candidate second decoding chain header in each candidate tuple is obtained based on application of a state change function on the first decoding chain header and a candidate value of the first data symbol included in the candidate decoding path of the corresponding candidate tuple;
execute a first sequence of steps on determining that a value of a second encoded symbol in the encoded symbol chain is valid, and a value of the counter is not equal to the overhead factor, the first sequence of steps comprising:
   generation of a second decoded symbol based the value of the second encoded symbol, wherein the second decoded symbol is one of identical to the second encoded symbol or a compliment of the second encoded symbol,
   updating of each candidate decoding path in each candidate tuple by including the second decoded symbol in each candidate decoding path such that each candidate decoding path includes a candidate value of the first data symbol and the second decoded symbol, and
   updating of each candidate second decoding chain header in each candidate tuple to obtain a candidate third decoding chain header, wherein the update involves an application of the state change function on each candidate second decoding chain header in each candidate tuple and the second decoded symbol;
execute a second sequence of steps on determining that a redundant encoded symbol is encountered in the encoded symbol chain if a value of the counter is equal to the overhead factor, the second sequence of steps comprising:
   generation of an expected redundant encoded symbol for each candidate tuple based on the candidate third decoding chain header in each candidate tuple, and
   selection of a candidate tuple from amongst the set of candidate tuples on determining that the expected redundant encoded symbol generated for the candidate tuple is identical to the redundant encoded symbol; and
   determine the candidate value of the first data symbol and the second decoded symbol included in the candidate decoding path in the selected candidate tuple as reconstructed versions of the first data symbol and a second data symbol in the data symbol chain, respectively.

The present disclosure provides the aforementioned first aspect and the aforementioned second aspect for encoding a data symbol chain. The present disclosure further provides the aforementioned third aspect and the aforementioned fourth aspect for decoding an encoded symbol chain. The encoding and the decoding are based on collision-free information chaining. This ensures that each data symbol in the data symbol chain maps to a unique encoded symbol, thereby eliminating random branching during decoding. Each encoded symbol in an encoded symbol chain is generated based on a data symbol through functions such as identity and negation, which ensures unique mappings. The encoding also involves updating a chain header at each instance of generation of an encoded symbol based on a previous chain header. The current chain header which is to be updated becomes the previous chain header during the update. The updated is also based on a data symbol used for the generation of the encoded symbol. There is no branching during the decoding because there is no uncertainty regarding ascertainment of a data symbol reconstructed from an encoded symbol.

Additionally, redundant encoded symbols are introduced in the encoded symbol chain, obtained based on encoding of the data symbol chain, at regular intervals in the encoded symbol chain. The decoding incorporates mechanisms to effectively handle erasures. For example, if an encoded symbol is detected as erased, multiple candidate values of a data symbol corresponding to the encoded symbol are stored which leads to multiple decoding paths. The redundant encoded symbols are used for pruning incorrect paths and select the actual candidate value of the data symbol. The encoding optimizes usage of the redundant encoded symbols, which allows reducing overhead while maintaining reliability. The redundant encoded symbols are strategically placed (after every predefined number of encoded symbols) in the encoded symbol chain to enable efficient handling of erasures. The optimized use of redundancy minimizes storage and bandwidth requirements.

The encoding and decoding processes are designed to be parallelizable, making implementation of the method suitable for hardware acceleration using field-programmable gate arrays (FPGAs) and application-specific integrated circuits (ASICs) that constitute the codec. This facilitates high-speed encoding and decoding. The collision-free information chaining ensures accurate data reconstruction, even in the presence of erasures and errors, and reduces a computational overhead in decoding, making the encoding and decoding processes suitable for usage in distributed systems and handling large-scale data transmission and storage. The encoding and decoding processes may be used in scenarios that include, but not limited to, peer-to-peer networks (such as blockchain systems) where efficient data propagation is essential, distributed storage systems where data durability/reliability are critical, high-latency communication networks where erasure handling is necessary, and compression systems combined with machine learning (ML) models (where compressing of data takes place during encoding).

Encoding embodiment (Algorithms 1, 2, 5 and 6 in the appendix).

The data symbol chain is received as an input by the encoder in the codec. The encoder encodes the data symbol chain when the data symbol chain is to be transmitted. The output of the encoder is the encoded symbol chain which comprises encoded symbols and redundant data symbols. Each encoded symbol corresponds to a data symbol in the data symbol chain. The redundant data symbols are inserted periodically between the encoded symbols. The encoded symbol chain is transmitted to a decoder for its reconstruction. Optionally, each data symbol in the data symbol chain includes at least one bit, wherein each encoded symbol in the encoded symbol chain, corresponding to a data symbol, is a bit if the data symbol is a bit, wherein each encoded symbol, corresponding to a data symbol, is a byte if the data symbol is a byte, and wherein a length of each redundant encoded symbol in the encoded symbol chain includes at least one bit.

In accordance with an embodiment, a length of an encoded symbol in the encoded symbol chain can be in the range 1-8. Thus, length of each encoded symbol can range from a bit to a byte. As there is a one-to-one correspondence between encoded symbols in the encoded symbol chain and data symbols in the data symbol chain, the length of the encoded symbols is same as that of the data symbols. For each data symbol, an encoded symbol is generated during the encoding. The length of the redundant encoded symbols may also vary in a certain range as per specific implementation of the encoder selected based on requirement.

For encoding the data symbol chain, the method includes initializing the nonce and the overhead factor. The nonce is an initial chain header. The encoding involves updating a chain header at each instance of encoding a data symbol, i.e., generation of an encoded symbol. For instance, after generation of the first encoded symbol (or encoding a first data symbol), the chain header is updated from the initial chain header (i.e., the nonce). Optionally, the nonce is one of a random number, a pseudo-random number, or a cryptographic key. The length of the nonce can be in a range of four bytes (i.e., 32 bits) to eight bytes (i.e., 64 bits). The overhead factor is indicative of an interval between redundant encoded symbols in the encoded symbol chain. For example, if the overhead factor “1”, then each encoded symbol in the encoded symbol chain is followed by a redundant encoded symbol. Similarly, if the overhead factor “2”, then a redundant encoded symbol is included after every two encoded symbols in the encoded symbol chain.

The encoded symbol chain comprises encoded symbols corresponding to data symbols in the data symbol chain and redundant encoded symbols that are inserted at periodic intervals based on the overhead factor. The generation of the encoded symbol chain includes a set of steps. The steps include generating an encoded symbol for each data symbol. In a first embodiment, the encoded symbol is identical to the corresponding data symbol. For instance, the first encoded symbol is identical to the first data symbol to which the first encoded symbol corresponds. This is true for each of the other encoded symbols. Thus, the second encoded symbol is identical to the second data symbol, the third encoded symbol is identical to the third data symbol, and so on. The last encoded symbol is identical to the last data symbol. In a second embodiment, the encoded symbol is a complement of the corresponding data symbol. For instance, the first encoded symbol is a complement of the first data symbol to which the first encoded symbol corresponds. For example, if the first data symbol is 1″, then the first encoded symbol is “0”. On the other hand, if the first data symbol is 110″, then the first encoded symbol is “001”. Thus, the second encoded symbol is a complement of the second data symbol, the third encoded symbol is a complement of the third data symbol, and so on. The last encoded symbol is a complement of the last data symbol.

The next step after the generation of an encoded symbol for each data symbol, is updating the chain header. The updating of the chain header involves the application of the state change function on the corresponding data symbol and a previous chain header. As discussed earlier, the nonce is the initial chain header. Thus, after the generation of the first encoded symbol corresponding to the first data symbol, the initial chain header is updated. The update involves applying the state change function on the first data symbol (corresponding to the first encoded symbol) and the nonce. This is because the nonce is the chain header that needs to be updated. The nonce becomes the previous chain header for the update. The nonce is referred to as the initial chain header since the chain header prior to any update is the nonce. The updated chain header will become the “previous chain header” for a subsequent update that is executed after generation of the second encoded symbol. The subsequent update will involve an application of the state change function on the second data symbol (which corresponds to the second encoded symbol) and the chain header (i.e., the previous chain header) obtained by updating the initial chain header.

Thus, the generation of an encoded symbol for each data symbol and updating of the chain header (after the generation of the encoded symbol) continues until a last encoded symbol in the data symbol chain is generated. After the generation of the last encoded symbol, the chain header is updated for the final time. The final update involves an application of the state change function on the last data symbol (which corresponds to the second encoded symbol) and the previous chain header. The previous chain header used for the final update is the chain header obtained after generation of a second-last encoded symbol corresponding to the second-last data symbol in the data symbol chain. The chain header obtained after the final update is the final chain header.

Optionally, the state change function is one of a XOR function, a hash function, a pseudo-random number generator, or a deterministic update heuristic means. Based on the state change function used, the updated chain header has various properties. For example, if the state change function is the XOR function, then the first update of the chain header is an outcome of an XOR operation of the initial chain header (i.e., the nonce) and the first data symbol. Similarly, the final update of the chain header is an outcome of an XOR operation of the chain header obtained after generation of a second-last encoded symbol and the second-last data symbol. The outcome of the XOR operation is the final chain header.

While encoded symbols corresponding to data symbols in the data symbol chain are generated, it is determined whether a predefined number of encoded symbols have been generated. The predefined number is equal to the overhead factor. If it is detected that the predefined number of encoded symbols have been generated, the method includes generating a redundant encoded symbol. For example, if the overhead factor is “3”, a redundant encoded symbol is generated after generation of every three encoded symbols. The redundant encoded symbol is generated based on the updated chain header. Considering the example, after the generation of a third encoded symbol, the chain header is updated. For the update, the chain header will become the “previous chain header”. The previous chain header is obtained after generation of the second encoded symbol. The updated chain header, i.e., the chain header obtained after the generation of the third encoded symbol, is obtained after the generation of the third encoded symbol is used for the generation of the redundant encoded symbol. Thereafter, the redundant encoded symbol is appended to the encoded symbol chain. Similarly, a redundant encoded symbol is generated after generation of a sixth encoded symbols and updating of a chain header that is obtained after generation of a fifth encoded symbol. Thus, redundant encoded symbols are generated after every instance of generation of the predefined number of encoded symbols and appended to the encoded symbol chain.

The encoded symbol chain comprising encoded symbols generated for each data symbol in the data symbol chain and redundant encoded symbols appended after every predefined number of encoded symbols equal to the overhead factor is the output of the encoder. The output of the encoder further includes the final chain header. For reconstruction of the data symbol chain, the encoded symbol chain, the final chain header, the nonce, and the overhead factor may be transmitted to a decoder (not the decoder of the codec when the codec is used as an encoder).

The present disclosure also relates to the second aspect as described above. Various embodiments and variants disclosed above, with respect to the aforementioned first aspect, apply mutatis mutandis to the second aspect.

A detailed description of embodiments of the third aspect of the present disclosure is as follows:

Decoding embodiment (Algorithms 3, 4, 7, and 8 in the appendix).

When an encoded symbol chain is received and is required to be decoded for reconstruct the data symbol chain, a breath first search is used. This involves the breadth first traversal of a tree that includes a set of paths representing a set of possible combinations of the data symbol chain. Each path starts with a root node representing the nonce and terminates at a leaf node representing the last data symbol in the data symbol chain. One path amongst the set of paths is the correct path. The correct path includes a sequence of data symbols match the data symbol chain which was encoded for generating the encoded symbol chain. The decoding involves searching this correct path.

The decoder of the codec receives, from an encoder (not the encoder of the codec when the codec is used as a decoder), the encoded symbol chain as input. The encoded symbol chain includes encoded symbols and redundant encoded symbols from which a data symbol chain is to be reconstructed. Additionally, the decoder receives a nonce, an overhead factor, and a final chain header from the encoder. Optionally, the encoded symbol chain is generated (by the encoder) by encoding the data symbol chain which is to be reconstructed (by the decoder). The nonce is one of a random number, a pseudo-random number, or a cryptographic key. The overhead factor is initialized (by the encoder) during encoding of the data symbol chain and is indicative of an interval between redundant encoded symbols in the encoded symbol chain. The final chain header (received by the decoder) is obtained (by the encoder) based on an application of a state change function (by the encoder) on a last data symbol in the data symbol chain and a chain header. The chain header is obtained (by the encoder) after generation of a second-last encoded symbol in the encoded symbol chain (received by the decoder).

The decoder is required to decode encoded symbols in the received encoded symbol chain. The decoding involves updating a decoding chain header after every instance of decoding an encoded symbol. The nonce is used (by the encoder) as an initial chain header. The nonce is updated (by the encoder) after a first data symbol in the data symbol chain has been encoded. The nonce (which is received by the decoder) is used as the first decoding chain header by the decoder. The nonce is updated after a first encoded symbol in the received encoded symbol chain has been decoded. The length of the nonce can be in a range of four bytes (i.e., 32 bits) to eight bytes (i.e., 64 bits).

The overhead factor is the interval between redundant encoded symbols in the received encoded symbol chain. For example, if the overhead factor “1”, then each encoded symbol in the encoded symbol chain is followed by a redundant encoded symbol. Similarly, if the overhead factor “2”, then a redundant encoded symbol in inserted after every two encoded symbols. The decoder compares the overhead factor with a value of a counter to determine whether a particular symbol encountered in the encoded symbol chain is a redundant encoded symbol or not. The symbol is identified as a redundant encoded symbol if the value of the counter is determined to be equal to the overhead factor (discussed later).

The final chain header is used for validating correctness of the decoded symbol chain after all encoded symbols in the encoded symbol chain have been decoded. In other words, the final chain header is used to verify whether all decoded symbols in the decoded symbol chain are identical to corresponding data symbols in the data symbol chain, which is to be reconstructed (discussed later).

Optionally, each encoded symbol in the (received) encoded symbol chain, corresponding to a data symbol in the data symbol chain, includes at least one bit. Each encoded symbol is a bit if a corresponding data symbol (to be reconstructed) in the data symbol chain is a bit. Each encoded symbol is a byte if a corresponding data symbol in the data symbol chain is a byte. A length of each redundant encoded symbol in the encoded symbol chain includes at least one bit. In accordance with an embodiment, the length of an encoded symbol may range can be in the range 1-8. Thus, length of each encoded symbol can range from a bit to a byte. For each data symbol in the data symbol chain, the encoder generates an encoded symbol. Since there is a one-to-one correspondence between encoded symbols in the (received) encoded symbol chain and data symbols in the data symbol chain (encoded by the encoder), the length of each encoded symbol is identical to a length of a corresponding data symbol (which is to be reconstructed). It is to be noted that each redundant encoded symbol can be of any length ranging from a bit to a byte. The length of redundant encoded symbols in the (received) encoded symbol chain depends on specific implementations of encoders and decoders.

When the encoded symbol chain is received and is required to be decoded to reconstruct the data symbol chain, the potential path representing the tuple is initialized. The tuple includes the decoded symbol chain and the first decoding chain header. The decoded symbol chain is empty during initialization (as no encoded symbol has been decoded at initialization) and the first decoding chain header is the nonce (as discussed earlier). The potential path at the end of decoding needs to be the correct path that is to be found by a decoding process (i.e., the breadth first search). The reconstruction of the data symbol chain (originally encoded by the encoder) involves decoding each encoded symbol in the encoded symbol chain such that the decoded symbol chain is obtained, which includes reconstructed versions of all data symbols in the data symbol chain.

In addition, the counter is initialized to track the number of encoded symbols that have already been decoded since encountering a redundant encoded symbol in the encoded symbol chain. In accordance with an embodiment, the counter is initialized to “0”. The counter is incremented at each instance of decoding of an encoded symbol. The counter is reset to “0” when a redundant encoded symbol is encountered. It may be noted that the counter is determined to be equal to the overhead factor when the redundant encoded symbol is encountered.

The decoding process comprises generating a decoded symbol for each encoded symbol in the encoded symbol chain. When it is determined that a value of an encoded symbol in the encoded symbol chain is invalid or is missing and a value of the counter is not equal to the overhead factor, a set of candidate tuples is initialized. For instance, the set of candidate tuples is initialized based on the determination that a value of a first encoded symbol in the encoded symbol chain is invalid or missing and that the value of the counter is not equal to the overhead factor. Each candidate tuple of the set of candidate tuples includes a candidate decoding path and a candidate second decoding chain header.

The number of candidate tuples included in the set of candidate tuples depends on the number of candidate values of the first data symbol corresponding to the first encoded symbol. For example, if the first data symbol is a bit, then the candidate values of the first data symbol are “0 and “1”. In this scenario, the initialized set of candidate tuples will include two candidate tuples. A first candidate tuple of the set of candidate tuples includes a first candidate decoding path and a candidate second decoding chain header. Similarly, a second candidate tuple of the set of candidate tuples includes a second candidate decoding path and a candidate second decoding chain header. The candidate second decoding chain header included in each candidate tuple of the set of candidate tuples is different.

Each candidate decoding path includes a candidate value of the first data symbol in the data symbol chain. Based on the above example, the first candidate decoding path in the first candidate tuple may include the candidate value “0” and the second candidate decoding path in the second candidate tuple may include the candidate value “1”. Each candidate second decoding chain header in each candidate tuple is obtained based on application of the state change function on the first decoding chain header and a candidate value of the first data symbol included in the candidate decoding path of the corresponding candidate tuple. Based on the example, the candidate second decoding chain header in the first candidate tuple is obtained based on the application of the state change function on the first decoding chain header (i.e., the nonce) and “0” (i.e., the candidate value of the first data symbol included in the first candidate decoding path in the first candidate tuple). Similarly, the candidate second decoding chain header in the second candidate tuple is obtained based on the application of the state change function on the first decoding chain header (i.e., the nonce) and “1” (i.e., the candidate value of the first data symbol included in the second candidate decoding path in the second candidate tuple).

Thus, at this stage, the first candidate tuple includes “0” (i.e., the candidate value of the first data symbol included in the first candidate decoding path in the first candidate tuple) and the candidate second decoding chain header obtained based on the nonce and “0”. The second candidate tuple includes “1” (i.e., the candidate value of the first data symbol included in the second candidate decoding path in the second candidate tuple) and the candidate second decoding chain header obtained based on the nonce and “1”.

Thereafter, a second encoded symbol is detected. The first sequence of steps is executed on determining that the value of the second encoded symbol in the encoded symbol chain is valid, and that a value of the counter is not equal to the overhead factor. The execution involves the generation of a second decoded symbol. The second decoded symbol is generated based the value of the second encoded symbol. Optionally, the second decoded symbol is one of identical to the second encoded symbol or a compliment of the second encoded symbol. Therefore, in a first embodiment, the second decoded symbol is identical to the second encoded symbol. For example, if a value of the second encoded symbol is “1”, then the second decoded symbol is “1”. On the other hand, if a value of the second encoded symbol is “0”, then the second decoded symbol is “0”. Furthermore, in a second embodiment, the second decoded symbol is a compliment of the second encoded symbol. For example, if a value of the second encoded symbol is “1”, then the second decoded symbol is “0”. On the other hand, if a value of the second encoded symbol is “0”, then the second decoded symbol is “1”.

The execution further involves updating each candidate decoding path in each candidate tuple by including the second decoded symbol in each candidate decoding path. Based on the above example, the first candidate decoding path includes “0” (i.e., a candidate value of the first data symbol) and the second decoded symbol. Similarly, the second candidate decoding path includes “1” (i.e., a candidate value of the first data symbol) and the second decoded symbol. Thus, each candidate decoding path is updated such that each candidate decoding path includes a candidate value of the first data symbol and the second decoded symbol.

The execution further involves updating each candidate second decoding chain header in each candidate tuple of the set of candidate tuples to obtain a candidate third decoding chain header. Each candidate second decoding chain header is updated is based on the application of the state change function on each candidate second decoding chain header in each candidate tuple and the second decoded symbol. Thus, the candidate second decoding chain header in the first candidate tuple is updated based on the application of the state change function on the candidate second decoding chain header in the first candidate tuple and the second decoded symbol. The update results in the obtaining of a candidate third decoding chain header. This third decoding chain header replaces the candidate second decoding chain header in the first candidate tuple. Similarly, the candidate second decoding chain header in the second candidate tuple is updated based on the application of the state change function on the candidate second decoding chain header in the second candidate tuple and the second decoded symbol. The update results in obtaining a candidate third decoding chain header. This third decoding chain header replaces the candidate second decoding chain header in the second candidate tuple.

At this stage, the first candidate tuple includes the first candidate decoding path comprising “0” and the second decoded symbol generated based on the value of the second encoded symbol. The first candidate tuple further includes the third decoding chain header obtained by updating the candidate second decoding chain header previously included in the first candidate tuple. The second candidate tuple includes the second candidate decoding path comprising “1” and the second decoded symbol generated based on the value of the second encoded symbol. The second candidate tuple further includes the third decoding chain header obtained by updating the candidate second decoding chain header previously included in the second candidate tuple.

Optionally, the state change function is one of an XOR function, a hash function, a pseudo-random number generator, or a deterministic update heuristic means. If the state change function is the XOR function, then the nonce is XORed with the candidate value of the first data symbol included in the first candidate decoding path to obtain the candidate second decoding chain header included in the first candidate tuple. Similarly, the candidate second decoding chain header in the first candidate tuple is XORed with the second decoded symbol to obtain the candidate third decoding chain header included in the first candidate tuple. Furthermore, the nonce is XORed with the candidate value of the first data symbol included in the second candidate decoding path to obtain the candidate second decoding chain header included in the second candidate tuple. Similarly, the candidate second decoding chain header in the second candidate tuple is XORed with the second decoded symbol to obtain the candidate third decoding chain header included in the second candidate tuple.

If the XOR function is used as the state change function, then the least significant bit (LSB) of the candidate second decoding chain header included in the first candidate tuple will be different from the LSB of the candidate second decoding chain header included in the second candidate tuple. Similarly, the LSB of the candidate third decoding chain header included in the first candidate tuple will be different from the LSB of the candidate third decoding chain header included in the second candidate tuple. This allows symmetric pruning of incorrect paths to select an actual candidate decoding chain header amongst multiple candidate decoding chain headers when a redundant encoded symbol is encountered in the encoded symbol chain.

Optionally, the method further comprises incrementing the counter in at least two conditions, wherein a first condition is the initialization of the set of candidate tuples, and wherein a second condition is the execution of the first sequence of steps. The set of candidate tuples are initialized for storing candidate values of the first data symbol in candidate decoding paths included in the candidate tuples of the set of candidate tuples. The counter is incremented to “1” (from the initialized value of “0”) based on inclusion of the different candidate values of the first data symbol in the candidate decoding paths included in the different candidate tuples of the set of candidate tuples. Furthermore, the counter is incremented to “2” (from “1”) when the second decoded symbol, generated based on the value of the second encoded symbol, are added to the candidate decoding paths in each of the candidate decoding paths included in the different candidate tuples. This is because the execution of the first sequence of steps involves inclusion of the second decoded symbol in each of the candidate decoding paths.

After the execution of the first sequence of steps, a redundant encoded symbol is encountered. The decoder determines that an encountered symbol in the encoded symbol chain is a redundant encoded symbol if the value of the counter is equal to the overhead factor. For example, a symbol following the second encoded symbol in the encoded symbol chain may be determined as a redundant encoded symbol if the overhead factor is “2”. As the value of the counter at this stage is “2”, the decoder determines that the symbol following the second encoded symbol is the redundant encoded symbol. The determination triggers the execution of the second sequence of steps. The value of the counter indicates that two encoded symbols have been decoded since a redundant encoded symbol was encountered. In the above example, a redundant encoded symbol is encountered for the first time.

The execution of the second sequence of steps involves generation of an expected redundant symbol for each candidate tuple included in the set of candidate tuples. The number of expected redundant symbols that are generated depends on the number of candidate tuples included in the set of candidate tuples. Based on the example, for the two candidate tuples included in the set of candidate tuples, two expected redundant symbols are generated. Each expected redundant symbol for each candidate tuple is generated based on the candidate third decoding chain header in each candidate tuple. A first expected redundant symbol for the first candidate tuple is generated based on the candidate third decoding chain header in the first candidate tuple while a second expected redundant symbol for the second candidate tuple is generated based on the candidate third decoding chain header in the second candidate tuple.

The execution further involves selecting a candidate tuple from amongst the set of candidate tuples. Based on the example, one tuple out of the two candidate tuples is selected. The selection is based on values of the generated expected redundant symbols. It is determined that the value of an expected redundant symbol, generated for a candidate tuple (of the set of candidate tuples), out of the two expected redundant symbols is identical to the encountered redundant data symbol. The selection of the candidate tuple is based on the determination. In a first scenario, the first candidate tuple is selected based on a determination that the value of the expected redundant symbol generated for the first candidate tuple is identical to the value of the encountered redundant encoded symbol. In a second scenario, the second candidate tuple is selected based on a determination that the value of the expected redundant symbol generated for the second candidate tuple is identical to the value of the encountered redundant encoded symbol. Thus, the selection of a correct candidate tuple amongst the set of candidate tuples is facilitated by the candidate third decoding chain header in each candidate tuple. The selection of the correct candidate tuple results in the pruning of an incorrect decoding path (i.e., the incorrect candidate decoding path).

Thereafter, the candidate value of the first data symbol and the second decoded symbol included in the candidate decoding path in the selected candidate tuple are determined as the reconstructed versions of the first data symbol and a second data symbol in the data symbol chain, respectively. Thus, if the first candidate tuple is selected, then the candidate value of the first data symbol and the second decoded symbol included in the first candidate decoding path in the first candidate tuple represent the reconstructed versions of the first data symbol and the second data symbol, respectively. Similarly, if the second candidate tuple is selected, then the candidate value of the first data symbol and the second decoded symbol included in the second candidate decoding path in the second candidate tuple represent the reconstructed versions of the first data symbol and the second data symbol, respectively.

Optionally, the method further comprises resetting the counter based on a determination that the value of the counter is equal to the overhead factor. As the value of the counter is determined to be equal to the overhead factor (i.e., “2”), the counter is reset (to “0”) when the redundant encoded symbol is detected in the encoded symbol chain.

Optionally, the method further comprises determining that a value of a third encoded symbol in the encoded symbol chain is valid, and a value of the counter is not equal to the overhead factor. The method further comprises generating a third decoded symbol based on a value of the third encoded symbol. The third decoded symbol is one of identical to the third encoded symbol or a compliment of the third encoded symbol. The third decoded symbol is a reconstructed version of a third data symbol in the data symbol chain. The method further comprises updating the candidate decoding path in the selected candidate tuple to include the third decoded symbol. The method further comprises updating the candidate third decoding chain header in the selected candidate tuple to obtain a fourth decoding chain header, wherein the update involves an application of the state change function on the candidate third decoding chain header in the selected candidate tuple and the generated third decoded symbol. The method further comprises updating the potential path by including the candidate decoding path in the selected candidate tuple as the decoded symbol chain and replacing the first decoding chain header with the fourth decoding chain header.

The third encoded symbol is detected after processing of the redundant encoded symbol (i.e., selection of the correct candidate tuple amongst the first set of candidate tuples) is completed. At this stage, the counter is not equal to the overhead factor (as it has been reset to “0”). After the detection of the third encoded symbol, it is determining that the value of a third encoded symbol in the encoded symbol chain is valid. Based on the detection, the third decoded symbol is generated. In a first embodiment, the decoded third symbol is identical to the third encoded symbol. Thus, if the value of the third encoded symbol is “0”, then the third decoded symbol is “0”. Conversely, if the value of the third encoded symbol is “1”, then the third decoded symbol is “1”. In a second embodiment, the decoded third symbol is the compliment of the third encoded symbol. Thus, if the value of the third encoded symbol is “0”, then the third decoded symbol is “1”. Conversely, if the value of the third encoded symbol is “1”, then the third decoded symbol is “0”. The third decoded symbol is the reconstructed version of the third data symbol in the data symbol chain.

For simplicity, it is considered that the first candidate tuple of the set of candidate tuples is selected. Thus, the first candidate decoding path in the first candidate tuple is updated to include the third encoded symbol. Thereafter, the candidate third decoding chain header in the first candidate tuple (i.e., the selected candidate tuple) is updated to obtain the fourth decoding chain header. The fourth decoding chain header is obtained by applying the state change function on the candidate third decoding chain header in the first candidate tuple (i.e., the selected candidate tuple) and the third decoded symbol.

After the updating of the candidate third decoding chain header, the potential path is updated. This involves including the candidate decoding path (i.e., the first candidate decoding path) in the selected candidate tuple (i.e., the first candidate tuple) as the decoded symbol chain (in the potential path). The first candidate decoding path includes the candidate value of the first data symbol (i.e., “0”), the second decoded symbol, and the third decoded symbol. The update in the potential path further involves replacing the first decoding chain header (which was included in the potential path during its initialization) with the fourth decoding chain header (obtained by updating the candidate third decoding chain header in the selected candidate tuple (i.e., the first candidate tuple).

Optionally, the method further comprises validating the decoded symbol chain, wherein the validation is successful based on detection of a match between the fourth decoding chain header and the final chain header. The match between the fourth decoding chain header and the final chain header is detected when the candidate value of the first data symbol included in the candidate decoding path in the selected candidate tuple (i.e., the first candidate decoding path in the first candidate tuple) is identical to the first data symbol in the data symbol chain, the second decoded symbol is identical to the second data symbol in the data symbol chain, and the third decoded symbol is identical to the third data symbol in the data symbol chain. When the match is detected, the decoding is successful, and the decoded symbol chain obtained after the updating of the potential path corresponds to the correct path.

It may be noted that the description of the embodiment comprising the method for decoding the encoded symbol chain is a simplified description. Whenever, a value of an encoded symbol in the encoded symbol chain is missing or is indeterminate, a set of candidate tuples is initialized. The candidate decoding path in each candidate tuple is expanded by adding decoded symbols, generated from subsequent encoded symbols, to the candidate decoding path in each candidate tuple. Furthermore, at each instance of encountering a redundant encoded symbol in the encoded symbol chain, a correct candidate decoding path, i.e., a correct candidate tuple of the set of candidate tuples can be selected.

It is to be noted that depth-first traversal may also be used for obtaining the data symbol chain and determine the correct path of the set of paths.

The present disclosure also relates to the fourth aspect as described above. Various embodiments and variants disclosed above, with respect to the aforementioned third aspect, apply mutatis mutandis to the fourth aspect.

### DETAILED DESCRIPTION OF THE DRAWINGS

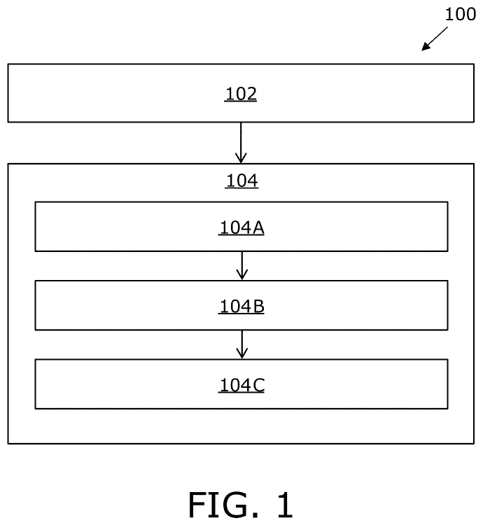

Referring to FIG. 1, there are illustrated steps of a method 100 for encoding a data symbol chain for generating an encoded symbol chain, in accordance with an embodiment of the present disclosure. At step 102, the method includes initializing a nonce and an overhead factor. The nonce is an initial chain header. The overhead factor is indicative of an interval between redundant encoded symbols in an encoded symbol chain. At step 104, the method includes generating the encoded symbol chain that comprises encoded symbols corresponding to data symbols in the data symbol chain and redundant data symbols. The generation of the encoded symbol chain includes steps 104A, 104B, and 104C.

At step 104A, the method includes generating an encoded symbol for each data symbol. The generated encoded symbol is either identical to the corresponding data symbol or a complement of the corresponding data symbol. At step 104B, the method includes updating a chain header based on application of a state change function on the corresponding data symbol and a previous chain header. The previous chain header is the nonce if the corresponding data symbol is a first data symbol in the data symbol chain. A final chain header is obtained based on the update if the corresponding data symbol is a last data symbol in the data symbol chain. The previous chain header that is used for the update is obtained after generation of a second-last encoded symbol corresponding to a second-last data symbol in the data symbol chain. At step 104C, the method includes generating a redundant encoded symbol after each instance of generation of a predefined number of encoded symbols that is equal to the overhead factor. The generation of the redundant encoded symbol is based on the updated chain header.

The aforementioned steps are only illustrative, and other alternatives can also be provided where one or more steps are added, one or more steps are removed, or one or more steps are provided in a different sequence without departing from the scope of the claims herein.

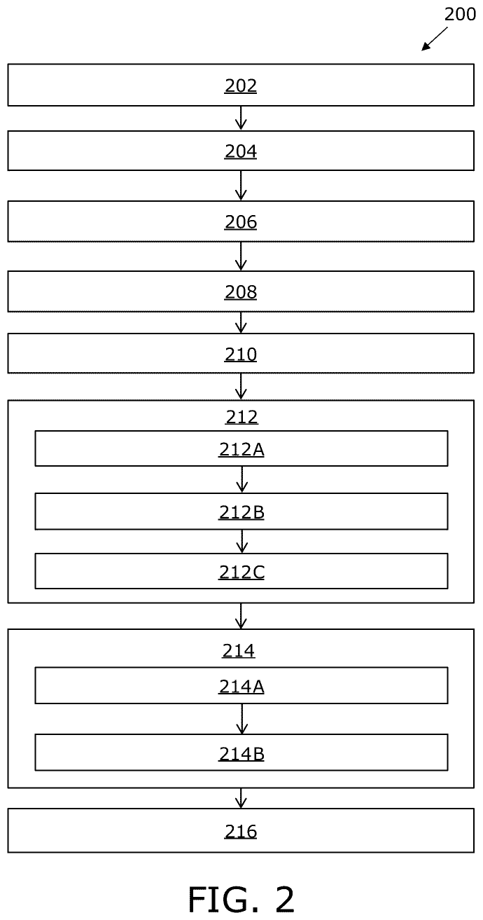

Referring to FIG. 2, there are illustrated steps of a method 200 for decoding an encoded symbol chain for reconstructing an original data symbol chain, in accordance with an embodiment of the present disclosure. At step 202, the method includes receiving the encoded symbol chain, a nonce, an overhead factor, and a final chain header. The encoded symbol chain includes encoded symbols and redundant encoded symbols. At step 204, the method includes initializing a potential path representing a tuple. The tuple includes a decoded symbol chain and a first decoding chain header. At initialization, the decoded symbol chain is empty, and the first decoding chain header is the nonce. At step 206, the method includes initializing a counter for tracking a number of encoded symbols that have been decoded since encountering a redundant encoded symbol in the encoded symbol chain. At step 208, the method includes determining that a value of a first encoded symbol in the encoded symbol chain is invalid or missing, and a value of the counter is not equal to the overhead factor. At step 210, the method includes initializing, based on the determination, a set of candidate tuples. Each candidate tuple of the set of candidate tuples includes a candidate decoding path and a candidate second decoding chain header. Each candidate decoding path includes a candidate value of a first data symbol in the data symbol chain. Each candidate second decoding chain header in each candidate tuple is obtained based on the application of a state change function on the first decoding chain header and a candidate value of the first data symbol included in the candidate decoding path of the corresponding candidate tuple.

At step 212, the method includes executing a first sequence of steps on determining that a value of a second encoded symbol in the encoded symbol chain is valid, and that a value of the counter is not equal to the overhead factor. The first sequence of steps includes steps 212A, 212B, and 212C. At step 212A, the method includes generating a second decoded symbol based the value of the second encoded symbol. The second decoded symbol is either identical to the second encoded symbol or a compliment of the second encoded symbol. At step 212B, the method includes updating each candidate decoding path in each candidate tuple by including the second decoded symbol in each candidate decoding path such that each candidate decoding path includes a candidate value of the first data symbol and the second decoded symbol. At step 212C, the method includes updating each candidate second decoding chain header in each candidate tuple to obtain a candidate third decoding chain header, wherein the update involves an application of the state change function on each candidate second decoding chain header in each candidate tuple and the second decoded symbol.

At step 214, the method includes executing a second sequence of steps on determining that a redundant encoded symbol is encountered in the encoded symbol chain if a value of the counter is equal to the overhead factor. The second sequence of steps includes steps 214A and 214B. At step 214A, the method includes generating an expected redundant encoded symbol for each candidate tuple based on the candidate third decoding chain header in each candidate tuple. At step 214B, the method includes selecting a candidate tuple from amongst the set of candidate tuples on determining that the expected redundant encoded symbol generated for the candidate tuple is identical to the redundant encoded symbol. At step 216, the method includes determining the candidate value of the first data symbol and the second decoded symbol included in the candidate decoding path in the selected candidate tuple as reconstructed versions of the first data symbol and a second data symbol in the data symbol chain, respectively.

The aforementioned steps are only illustrative, and other alternatives can also be provided where one or more steps are added, one or more steps are removed, or one or more steps are provided in a different sequence without departing from the scope of the claims herein.

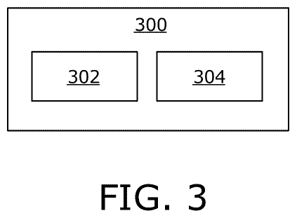

Referring to FIG. 3, there is illustrated a block diagram of a codec 300 that is operable to encode a data symbol chain or decode an encoded symbol chain, in accordance with an embodiment of the present disclosure. As illustrated in FIG. 3, the codec 300 comprises an encoder 302 and a decoder 304. At any instant, the codec 300 may function as an encoder whereby the encoder 302 receives the data symbol chain as input and generates an encoded symbol chain as output. At another instant, the codec 300 may function as a decoder whereby the decoder 304 receives an encoded symbol chain as input and generates, as output, a reconstructed version of the original data symbol chain.

The encoder 302 is operable to transform the data symbol chain into an encoded symbol chain. The transformation is such that collision-free mappings between data symbols and encoded symbols are ensured. Furthermore, redundancy is introduced in the form of redundant encoded symbols in the encoded symbol chain for handling of erasures at decoder-side. The encoding begins with the initialization of the nonce, which acts as the initial chain header. The encoding involves updating a chain header at each instance of generation of an encoded symbol from a data symbol. For each data symbol, the encoder 302 generates an encoded symbol, wherein the encoded symbol is either identical to the data symbol or a compliment of the data symbol. This ensures that each encoded symbol is uniquely mapped to its corresponding data symbol, thereby preventing collisions during decoding. After the generation of each encoded symbol, the chain header is updated using a state change function, which ensures that the header evolves in a deterministic, yet unique manner for each symbol. The state change function, for the update, is applied on a data symbol that is latest to be encoded, and the previous chain header that was obtained after generating a previous data symbol that is latest to be encoded. The updated chain header is used for generating redundant encoded symbols at periodic intervals in the data symbol chain.

To enhance robustness, the encoder 302 introduces redundant encoded symbols at regular intervals defined by a parameter overhead factor. After generation of the predefined number of encoded symbols equal to the overhead factor, a redundant encoded symbol is generated using the updated chain header. The redundant encoded symbol is appended to the encoded symbol chain. The inclusion of the redundant encoded symbols allows pruning incorrect paths during decoding, which ensures accurate reconstruction of the data symbols even in the presence of erasures. The encoder 302 outputs the encoded symbol chain that includes an encoded symbol for each data symbol and redundant encoded symbols, and a final chain header, which serves as a reference for a decoder which may decode the encoded symbol chain.

The decoder 304 is designed to reconstruct the original data symbol chain from the encoded symbol chain. The decoder 304 receives (apart from the encoded symbol chain), a nonce, an overhead factor, and a final chain header (used for verifying correctness of a decoded symbol chain). The decoder 204 initializes a potential path, which includes a decoded symbol chain and first decoding chain header, which is the nonce. At initialization, the decoded symbol chain is empty. The decoding process iterates over all symbols in the encoded symbol chain that includes encoded symbols and redundant encoded symbols. At each iteration, an encoded symbol is decoded to generate a decoded symbol which is added to the decoded symbol chain. Furthermore, a decoding chain header (which is the first decoding chain header at initialization) in the potential path is also updated at each iteration. For instance, during the first iteration, the first decoding chain header is updated based on a first decoded symbol and the first chain header to obtain a second decoding chain header. If a value of an encoded symbol is missing (due to an erasure or error during transmission), the decoder 204 evaluates all candidate values of a data symbol corresponding to the encoded symbol.

As the decoding is based on collision-free information chaining (i.e., each data symbol maps uniquely to an encoded symbol), candidate decoding paths including candidate values of the data symbols, which correspond to branches of a tree, need to be initialized only in the presence of erasures. At each instance of encountering a redundant encoded symbol, the decoder 304 uses the redundant encoded symbol to prune incorrect paths. In other words, incorrect candidate decoding paths that include incorrect candidate values of data symbols (whose corresponding encoded symbols are missing) are removed. This ensures that only valid candidate decoding paths including valid candidate values are retained as the decoding progresses.

After processing all encoded symbols, i.e., obtaining a decoded symbol for each encoded symbol in the encoded symbol chain, a final decoding chain header is obtained. The final decoding chain header is obtained based on a valid last decoded symbol and a decoding chain header that was obtained after generation of the valid last decoded symbol. After the generation of the valid decoded last symbol, the decoded symbol chain includes reconstructed versions of all data symbols in the data symbol chain. At this stage, the decoder 304 compares the final decoding chain header with the final chain header (received as input). This ensures that the correct path in the tree was traversed during the decoding.

It may be understood by a person skilled in the art that FIG. 3 includes a simplified architecture of the codec 300, for the sake of clarity, which should not unduly limit the scope of the claims herein. It is to be understood that the specific implementation of the codec 300 is provided as an example and is not to be construed as limiting. The person skilled in the art will recognize variations, alternatives, and modifications of embodiments of the present disclosure.

### APPENDIX

Algorithm 1:

| | |
|---|---|
| 1: | procedure Encode(input: array of booleans, nonce: |
| | integer, m: integer) |
| 2: | code ← empty array |
| 3: | chain_header ← nonce |
| 4: | for i ← 0 to length(input) − 1 do |
| 5: | e ← input[i] |
| 6: | chain_header ← StateChange(chain_header, e) |
| 7: | Append e to code |
| 8: | if (i + 1) mod m = 0 then |
| 9: | redundant_e ← (chain_header mod 2 = 1) |
| 10: | Append redundant_e to code |
| 11: | end if |
| 12: | end for |
| 13: | return (code, chain_header) |
| 14: | end procedure |

Algorithm 2:

| | |
|---|---|
| 1: | procedure Encode(input: array of booleans, nonce: |
| | integer, m: integer) |
| 2: | code ← empty array |
| 3: | chain_header ← nonce |
| 4: | for i ← 0 to length(input) − 1 do |
| 5: | e ← ¬ input[i] |
| 6: | chain_header ← StateChange(chain_header, s) |
| 7: | Append e to code |
| 8: | if (i + 1) mod m = 0 then |
| 9: | redundant_e ← (chain_header mod 2 = 1) |
| 10: | Append redundant_e to code |
| 11: | end if |
| 12: | end for |
| 13: | return (code, chain_header) |
| 14: | end procedure |

Algorithm 3:

| | |
|---|---|
| 1: | procedure Decode(code: array of booleans, nonce: |
| | integer, final header: integer, n: integer, m: integer, |
| | holes: array of booleans) |
| 2: | potential_paths ← queue containing (empty array, |
| | nonce) |
| 3: | symbol_set ← {false, true} |
| 4: | position ← 0 |
| 5: | for i ← 0 to n − 1 do |
| 6: | s ← code[position] |
| 7: | hole ← holes[position] |
| 8: | is_redundant_bit ← (i + 1) mod m = 0 |
| 9: | if is_redundant_bit then |
| 10: | position ← position + 1 |
| 11: | redundant_e ← code[position] |
| 12: | redundant_hole ← holes[position] |
| 13: | else |
| 14: | redundant_e ← false |
| 15: | redundant_hole ← false |
| 16: | end if |
| 17: | branches ← empty queue |
| 18: | while potential_paths is not empty do |
| 19: | (path, previous_chain_header) ← |
| | dequeue(potential_paths) |
| 20: | branch_iterator ← symbol_set if hole else {s} |
| 21: | for each s′ in branch_iterator do |
| 22: | chain_header ← |
| | StateChange(previous_chain_header, s′) |
| 23: | redundant_e′ ← (chain_header mod 2 = 1) |
| 24: | redundant ← (redundant_e′ = redundant_e) or |
| | redundant_hole |
| 25: | if not is_redundant_bit or redundant then |
| 26: | new_path ← copy of path with s′ appended |
| 27: | enqueue(branches, (new_path, |
| | chain_header)) |
| 28: | end if |
| 29: | end for |
| 30: | end while |
| 31: | potential_paths ← branches |
| 32: | position ← position + 1 |
| 33: | end for |
| 34: | for each (potential_path, potential_header) in |
| | potential_paths do |
| 35: | if potential_header = final_header then |
| 36: | return potential_path |
| 37: | end if |
| 38: | end for |
| 39: | return None |
| 40: | end procedure |

Algorithm 4:

| | |
|---|---|
| 1: | procedure Decode(code: array of booleans, nonce: |
| | integer, final header: integer, n: integer, m: integer, |
| | holes: array of booleans) |
| 2: | potential_paths ← queue containing (empty array, |
| | nonce) |
| 3: | symbol_set ← {false, true} |
| 4: | position ← 0 |
| 5: | for i ← 0 to n − 1 do |
| 6: | e ← code[position] |
| 7: | hole ← holes[position] |
| 8: | is_redundant_bit ← (i + 1) mod m = 0 |
| 9: | if is_redundant_bit then |
| 10: | position ← position + 1 |
| 11: | redundant_e ← code[position] |
| 12: | redundant_hole ← holes[position] |
| 13: | else |
| 14: | redundant_e ← false |
| 15: | redundant_hole ← false |
| 16: | end if |
| 17: | branches ← empty queue |
| 18: | while potential_paths is not empty do |
| 19: | (path, previous_chain_header) ← |
| | dequeue(potential_paths) |
| 20: | branch_iterator ← symbol_set if hole else {e} |
| 21: | for each symbol in branch_iterator do |
| 22: | s′ ← (¬ symbol) |
| 23: | chain_header ← |
| | StateChange(previous_chain_header, s′) |
| 24: | redundant_e′ ← (chain_header mod 2 = 1) |
| 25: | redundant ← (redundant_e′ = redundant_e) or |
| | redundant_hole |
| 26: | if not is_redundant_bit or redundant then |
| 27: | new_path ← copy of path with s′ appended |
| 28: | enqueue(branches, (new_path, |
| | chain_header)) |
| 29: | end if |
| 30: | end for |
| 31: | end while |
| 32: | potential_paths ← branches |
| 33: | position ← position + 1 |
| 34: | end for |
| 35: | for each (potential_path, potential_header) in |
| | potential_paths do |
| 36: | if potential_header = final_header then |
| 37: | return potential_path |
| 38: | end if |
| 39: | end for |
| 40: | return None |
| 41: | end procedure |

Algorithm 5:

| | |
|---|---|
| 1: | procedure XorShiftStateChange(chain_header: |
| | integer, s: boolean) |
| 2: | chain_header ← chain_header XOR |
| | (chain_header << 5) |
| 3: | chain_header ← chain_header XOR |
| | (chain_header >> 7) |
| 4: | return chain_header XOR s |
| 5: | end procedure |
| 6: | |
| 7: | procedure Encode(input: array of booleans, nonce: |
| | integer, m: integer) |
| 8: | code ← empty array |
| 9: | chain_header ← nonce |
| 10: | for i ← 0 to length(input) − 1 do |
| 11: | e ← input[i] |
| 12: | chain_header ← |
| | XorShiftStateChange(chain_header, e) |
| 13: | Append e to code |
| 14: | if (i + 1) mod m = 0 then |
| 15: | redundant_e ← chain_header mod 2 |
| 16: | Appendredundant_etocode |
| 17: | end if |
| 18: | end for |
| 19: | return (code, chain_header) |
| 20: | end procedure |

Algorithm 6:

| | |
|---|---|
| 1: | procedure XorShiftStateChange(chain_header: |
| | integer, s: boolean) |
| 2: | chain_header ← chain_header XOR |
| | (chain_header << 5) |
| 3: | chain_header ← chain_header XOR |
| | (chain_header >> 7) |
| 4: | return chain_header XOR s |
| 5: | end procedure |
| 6: | |
| 7: | procedure Encode(input: array of booleans, nonce: |
| | integer, m: integer) |
| 8: | code ← empty array |
| 9: | chain_header ← nonce |
| 10: | for i ← 0 to length(input) − 1 do |
| 11: | e ← ¬ input[i] |
| 12: | chain_header ← |
| | XorShiftStateChange(chain_header, s) |
| 13: | Append e to code |
| 14: | if (i + 1) mod m = 0 then |
| 15: | redundant_e ← chain_header mod 2 |
| 16: | Appendredundant_etocode |
| 17: | end if |
| 18: | end for |
| 19: | return (code, chain_header) |
| 20: | end procedure |

Algorithm 7:

| | |
|---|---|
| 1: | procedure Decode(code: array of booleans, nonce: |
| | integer, final header: integer, n: integer, m: integer, |
| | holes: array of booleans) |
| 2: | potential_paths ← queue containing (empty array, |
| | nonce) |
| 3: | symbol_set ← {false, true} |
| 4: | position ← 0 |
| 5: | for i ← 0 to n − 1 do |
| 6: | S ← code[position] |
| 7: | hole ← holes[position] |
| 8: | is_redundant_bit ← (i + 1) mod m = 0 |
| 9: | if is_redundant_bit then |
| 10: | position ← position + 1 |
| 11: | redundant_e ← code[position] |
| 12: | redundant_hole ← holes[position] |
| 13: | else |
| 14: | redundant_e ← false |
| 15: | redundant_hole ← false |
| 16: | end if |
| 17: | branches ← empty queue |
| 18: | while potential_paths is not empty do |
| 19: | (path, previous_chain_header) ← |
| | dequeue(potential_paths) |
| 20: | branch_iterator ← symbol_set if hole else {s} |
| 21: | for each s′ in branch_iterator do |
| 22: | chain_header←XorShiftState- |
| | Change(previous_chain_header, s′) |
| 23: | redundant_e′ ← (chain_header mod 2 = 1) |
| 24: | redundant←(redundant_e′=redundant_e) or |
| | redundant_hole |
| 25: | if not is_redundant_bit or redundant then |
| 26: | new_path ← copy of path with s′ appended |
| 27: | enqueue(branches, (new_path, |
| | chain_header)) |
| 28: | end if |
| 29: | end for |
| 30: | end while |
| 31: | potential_paths ← branches |
| 32: | position ← position + 1 |
| 33: | end for |
| 34: | for each (potential_path, potential_header) in |
| | potential_paths do |
| 35: | if potential_header = final_header then |
| 36: | return potential_path |
| 37: | end if |
| 38: | end for |
| 39: | return None |
| 40: | end procedure |

Algorithm 8:

| | |
|---|---|
| 1: | procedure Decode(code: array of booleans, nonce: |
| | integer, final header: integer, n: integer, m: integer, |
| | holes: array of booleans) |
| 2: | potential_paths ← queue containing (empty array, |
| | nonce) |
| 3: | symbol_set ← {false, true} |
| 4: | position ← 0 |
| 5: | for i ← 0 to n − 1 do |
| 6: | e ← code[position] |
| 7: | hole ← holes[position] |
| 8: | is_redundant_bit ← (i + 1) mod m = 0 |
| 9: | if is_redundant_bit then |
| 10: | position ← position + 1 |
| 11: | redundant_e ← code[position] |
| 12: | redundant_hole ← holes[position] |
| 13: | else |
| 14: | redundant_e ← false |
| 15: | redundant_hole ← false |
| 16: | end if |
| 17: | branches ← empty queue |
| 18: | while potential_paths is not empty do |
| 19: | (path, previous_chain_header) ← |
| | dequeue(potential paths) |
| 20: | branch_iterator ← symbol_set if hole else {e} |
| 21: | for each s′ in branch iterator do |
| 22. | s′ ← (¬ symbol) |
| 23: | chain_header ← XorShiftState- |
| | Change(previous_chain_header, s′) |
| 24: | redundant_e′ ← (chain_header mod 2 = 1) |
| 25: | redundant←(redundant_e′=redundant_e)or |
| | redundant_hole |
| 26: | if not is_redundant_bit or redundant then |
| 27: | new_path ← copy of path with s′ appended |
| 28: | enqueue(branches, (new_path, |
| | chain_header)) |
| 29: | end if |
| 30: | end for |
| 31: | end while |
| 32: | potential_paths ← branches |
| 33: | position ← position + 1 |
| 34: | end for |
| 35: | for each (potential_path, potential_header) in |
| | potential_paths do |
| 36: | if potential_header = final_header then |
| 37: | return potential_path |
| 38: | end if |
| 39: | end for |
| 40: | return None |
| 41: | end procedure |

What is claimed is:

1. A method for encoding a data symbol chain, the method comprising:
initializing a nonce and an overhead factor, wherein the nonce is an initial chain header, and wherein the overhead factor is indicative of an interval between redundant encoded symbols in an encoded symbol chain; and
generating the encoded symbol chain comprising encoded symbols corresponding to data symbols in the data symbol chain and redundant data symbols, wherein the generation includes a set of steps comprising:
generating an encoded symbol for each data symbol, wherein the encoded symbol is one of: identical to the corresponding data symbol or a complement of the corresponding data symbol,
updating a chain header based on application of a state change function on the corresponding data symbol and a previous chain header, wherein the previous chain header is the nonce if the corresponding data symbol is a first data symbol in the data symbol chain, and wherein a final chain header is obtained based on the update if the corresponding data symbol is a last data symbol in the data symbol chain, and
generating a redundant encoded symbol after each instance of generation of a predefined number of encoded symbols that is equal to the overhead factor, and wherein the generation is based on the updated chain header.

2. The method according to claim 1, wherein each data symbol in the data symbol chain includes at least one bit, wherein each encoded symbol in the encoded symbol chain, corresponding to a data symbol, is a bit if the data symbol is a bit, wherein each encoded symbol, corresponding to a data symbol, is a byte if the data symbol is a byte, and wherein a length of each redundant encoded symbol in the encoded symbol chain includes at least one bit.

3. The method according to claim 1, wherein the nonce is one of: a random number, a pseudo-random number, or a cryptographic key.

4. The method according to claim 1, wherein the state change function is one of a XOR function, a hash function, a deterministic update heuristic means, or a pseudo-random number generating function.

5. A method for decoding an encoded symbol chain for reconstructing a data symbol chain, the method comprising:
receiving the encoded symbol chain, a nonce, an overhead factor, and a final chain header, wherein the encoded symbol chain includes encoded symbols and redundant encoded symbols;
initializing a potential path representing a tuple, wherein the tuple includes a decoded symbol chain and a first decoding chain header, and wherein at initialization the decoded symbol chain is empty, and the first decoding chain header is the nonce;
initializing a counter for tracking a number of encoded symbols that have been decoded since encountering a redundant encoded symbol in the encoded symbol chain;
determining that a value of a first encoded symbol in the encoded symbol chain is invalid or missing, and a value of the counter is not equal to the overhead factor;
initializing, based on the determination, a set of candidate tuples, wherein each candidate tuple of the set of candidate tuples includes a candidate decoding path and a candidate second decoding chain header, wherein each candidate decoding path includes a candidate value of a first data symbol in the data symbol chain, and
wherein each candidate second decoding chain header in each candidate tuple is obtained based on application of a state change function on the first decoding chain header and a candidate value of the first data symbol included in the candidate decoding path of the corresponding candidate tuple;
executing a first sequence of steps on determining that a value of a second encoded symbol in the encoded symbol chain is valid, and a value of the counter is not equal to the overhead factor, the first sequence of steps comprising:
generating a second decoded symbol based the value of the second encoded symbol,
updating each candidate decoding path in each candidate tuple by including the second decoded symbol in each candidate decoding path such that each candidate decoding path includes a candidate value of the first data symbol and the second decoded symbol, and
updating each candidate second decoding chain header in each candidate tuple to obtain a candidate third decoding chain header, wherein the update involves an application of the state change function on each candidate second decoding chain header in each candidate tuple and the second decoded symbol;
executing a second sequence of steps on determining that a redundant encoded symbol is encountered in the encoded symbol chain if a value of the counter is equal to the overhead factor, the second sequence of steps comprising:
generating an expected redundant encoded symbol for each candidate tuple based on the candidate third decoding chain header in each candidate tuple, and
selecting a candidate tuple from amongst the set of candidate tuples on determining that the expected redundant encoded symbol generated for the candidate tuple is identical to the redundant encoded symbol; and
determining the candidate value of the first data symbol and the second decoded symbol included in the candidate decoding path in the selected candidate tuple as reconstructed versions of the first data symbol and a second data symbol in the data symbol chain, respectively.

6. The method according to claim 5, wherein the second decoded symbol is one of identical to the second encoded symbol or a compliment of the second encoded symbol.

7. The method according to claim 5, wherein the encoded symbol chain is generated by encoding the data symbol chain, which is to be reconstructed.

8. The method according to claim 5, wherein the nonce is one of: a random number, a pseudo-random number, or a cryptographic key.

9. The method according to claim 5, wherein the overhead factor is initialized during encoding of the data symbol chain and is indicative of an interval between redundant encoded symbols in the encoded symbol chain.

10. The method according to claim 5, wherein the final chain header is obtained based on application of the state change function on a last data symbol in the data symbol chain and a chain header, wherein the chain header is obtained after generation of a second-last encoded symbol in the encoded symbol chain.

11. The method according to claim 5, wherein each encoded symbol in the encoded symbol chain, corresponding to a data symbol in the data symbol chain, includes at least one bit, wherein each encoded symbol is a bit if a corresponding data symbol in the data symbol chain is a bit, wherein each encoded symbol is a byte if a corresponding data symbol in the data symbol chain is a byte, and wherein a length of each redundant encoded symbol in the encoded symbol chain includes at least one bit.

12. The method according to claim 5, wherein the state change function is one of: an XOR function, a hash function, a pseudo-random number generator, or a deterministic update heuristic means.

13. The method according to claim 5, wherein the method further comprises incrementing the counter in at least two conditions, wherein a first condition is the initialization of the set of candidate tuples, and wherein a second condition is the execution of the first sequence of steps.

14. The method according to claim 5, wherein the method further comprises resetting the counter based on a determination that the value of the counter is equal to the overhead factor.

15. The method according to claim 5, wherein the method further comprises:
determining that a value of a third encoded symbol in the encoded symbol chain is valid, and the value of the counter is not equal to the overhead factor;
generating a third decoded symbol based the value of the third encoded symbol, wherein the third decoded symbol is one of identical to the third encoded symbol or a compliment of the third encoded symbol, and wherein the third decoded symbol is a reconstructed version of a third data symbol in the data symbol chain; and
updating the candidate decoding path in the selected candidate tuple to include the third decoded symbol.

16. The method according to claim 5, wherein the method further comprises updating the candidate third decoding chain header in the selected candidate tuple to obtain a fourth decoding chain header, wherein the update involves an application of the state change function on the candidate third decoding chain header in the selected candidate tuple and the third decoded symbol.

17. The method according to claim 5, wherein the method further comprises updating the potential path by including the candidate decoding path in the selected candidate tuple as the decoded symbol chain and replacing the first decoding chain header with the fourth decoding chain header.

18. The method according to claim 5, wherein the method further comprises validating the decoded symbol chain, wherein the validation is successful based on detection of a match between the fourth decoding chain header and the final chain header.

19. A codec for encoding a data symbol chain, wherein an encoder of the codec is operable to:
initialize a nonce and an overhead factor, wherein the nonce is an initial chain header, and wherein the overhead factor is indicative of an interval between redundant encoded symbols in an encoded symbol chain; and
generate the encoded symbol chain comprising encoded symbols corresponding to data symbols in the data symbol chain and redundant data symbols, wherein the generation includes a set of steps comprising:
generation of an encoded symbol for each data symbol, wherein the encoded symbol is one of: identical to the corresponding data symbol or a complement of the corresponding data symbol,
updating of a chain header based on application of a state change function on the corresponding data symbol and a previous chain header, wherein the previous chain header is the nonce if the corresponding data symbol is a first data symbol in the data symbol chain, and wherein a final chain header is obtained based on the update if the corresponding data symbol is a last data symbol in the data symbol chain, and
generation of a redundant encoded symbol after each instance of generation of a predefined number of encoded symbols that is equal to the overhead factor, and wherein the generation is based on the updated chain header.

20. A codec for decoding an encoded symbol chain for reconstruction of a data symbol chain, wherein a decoder of the codec is operable to:
receive the encoded symbol chain, a nonce, an overhead factor, and a final chain header, wherein the encoded symbol chain includes encoded symbols and redundant encoded symbols;
initialize a potential path representing a tuple, wherein the tuple includes a decoded symbol chain and a first decoding chain header, and wherein at initialization the decoded symbol chain is empty, and the first decoding chain header is the nonce;
initialize a counter for tracking a number of encoded symbols that have been decoded since encountering a redundant encoded symbol in the encoded symbol chain;
determine that a value of a first encoded symbol in the encoded symbol chain is invalid or missing, and a value of the counter is not equal to the overhead factor;
initialize, based on the determination, a set of candidate tuples, wherein each candidate tuple of the set of candidate tuples includes a candidate decoding path and a candidate second decoding chain header,
wherein each candidate decoding path includes a candidate value of a first data symbol in the data symbol chain, and
wherein each candidate second decoding chain header in each candidate tuple is obtained based on application of a state change function on the first decoding chain header and a candidate value of the first data symbol included in the candidate decoding path of the corresponding candidate tuple;
execute a first sequence of steps on determining that a value of a second encoded symbol in the encoded symbol chain is valid, and a value of the counter is not equal to the overhead factor, the first sequence of steps comprising:
generation of a second decoded symbol based the value of the second encoded symbol, wherein the second decoded symbol is one of identical to the second encoded symbol or a compliment of the second encoded symbol,
updating of each candidate decoding path in each candidate tuple by including the second decoded symbol in each candidate decoding path such that each candidate decoding path includes a candidate value of the first data symbol and the second decoded symbol, and
updating of each candidate second decoding chain header in each candidate tuple to obtain a candidate third decoding chain header, wherein the update involves an application of the state change function on each candidate second decoding chain header in each candidate tuple and the second decoded symbol;
execute a second sequence of steps on determining that a redundant encoded symbol is encountered in the encoded symbol chain if a value of the counter is equal to the overhead factor, the second sequence of steps comprising:
generation of an expected redundant encoded symbol for each candidate tuple based on the candidate third decoding chain header in each candidate tuple, and
selection of a candidate tuple from amongst the set of candidate tuples on determining that the expected redundant encoded symbol generated for the candidate tuple is identical to the redundant encoded symbol; and
determine the candidate value of the first data symbol and the second decoded symbol included in the candidate decoding path in the selected candidate tuple as reconstructed versions of the first data symbol and a second data symbol in the data symbol chain, respectively.
